(19) United States
(12) Patent Application Publication
(10) Pub. No.: US 2009/0105949 A1
(43) Pub. Date: Apr. 23, 2009

(54) Generation in a mobile device of a traffic map based on traffic messages

(75) Inventor: Ronen Bitan, Har Dar (IL)

Correspondence Address: CARR & FERRELL LLP, 2200 GENG ROAD, PALO ALTO, CA, 94303, US

(73) Assignee: Destinator Technologies, Inc.

(21) Appl. No.: 11/977,341

(22) Filed: Oct. 23, 2007

(51) Int. Cl. G01C 21/00; G01S 5/00

(52) U.S. Cl. 701/212; 701/208

(57) ABSTRACT

A Global Positioning System (GPS) enabled mobile device includes traffic map generation capability. The mobile device receives traffic messages including information about a traffic event. Based on the information included in the traffic messages and a current location, the mobile device generates a traffic map depicting a location of the traffic event and the current location.

### BACKGROUND

1. Field of the Invention

This invention relates generally to the field of global positioning systems (GPS) and more specifically to generation of a traffic map in a mobile device.

2. Description of Related Art

A global positioning system (GPS) in a GPS-enabled mobile device is able to determine a current location. As is known in the art, the GPS-enabled mobile device additionally includes maps such as road maps or topographical maps and is able to correlate its current location to these maps.

Traffic events such as accidents, congestion, roadwork, weather conditions, or the like can delay travel on roadways. Currently, the GPS-enabled device may receive previously prepared roadmaps indicating the traffic events. The previously prepared roadmaps, however, may only cover a limited area or include a limited amount of detail. To keep the information in the traffic map current, the GPS-enabled device must receive another previously-prepared traffic map;

Therefore, there is a need for mobile devices to provide more detailed and up-to-date traffic information.

### SUMMARY

A Global Positioning System (GPS) enabled mobile device includes traffic map generation capability. The mobile device receives a traffic message about a traffic event. The traffic message includes an event code corresponding to a description of the traffic event and a location code corresponding to the location of the event. Based on the location code, a determination is made as to whether the traffic event is within a predetermined distance of the current location. If the traffic event is within the predetermined distance, the mobile device generates a traffic map. The traffic map includes an event graphic corresponding to the event code of the identified traffic message and placed on the traffic map according to the event location.

In various embodiments, a system comprises a global positioning system module, a traffic message receiver, a traffic module, and a map module. The global positioning system module is configured to determine a current location. The traffic message receiver is configured to receive traffic messages each comprising an event code and a location code. The traffic module is configured to identify a traffic message of the traffic messages having an event location within a predetermined distance of the current location based on the location code of the traffic message. The map module configured to generate a traffic map of an area comprising the current location and the event location of the identified traffic message. The traffic map comprises an event graphic corresponding to the event code of the identified traffic message, and the event graphic is placed on the traffic map according to the event location of the identified traffic message.

In various embodiments, a method comprises determining a current location of a mobile device and receiving, at the mobile device, traffic messages each comprising an event code and a location code. A traffic message of the traffic messages having an event location within a predetermined distance of the current location based on the location code of the traffic message is identified. A traffic map of an area comprising the current location and the event location of the identified traffic message is generated. The traffic map comprises an event graphic corresponding to the event code of the identified traffic message, and the event graphic is placed on the traffic map according to the event location of the identified traffic message.

In various embodiments, a computer readable medium has embodied thereon instructions executable by a processor for performing a method for generating a traffic map. The method comprises determining a current location of a mobile device and receiving, at the mobile device, traffic messages each comprising an event code and a location code. A traffic message of the traffic messages having an event location within a predetermined distance of the current location based on the location code of the traffic message is identified. A traffic map of an area comprising the current location and the event location of the identified traffic message is generated. The traffic map comprises an event graphic corresponding to the event code of the identified traffic message, and the event graphic is placed on the traffic map according to the event location of the identified traffic message.

### BRIEF DESCRIPTION OF THE DRAWINGS

FIG. 1 is an illustration of an exemplary path of a traffic message to a mobile device;

FIG. 2 is a block diagram of the mobile device according to various embodiments;

FIG. 3 is a flowchart of an exemplary process for generating a traffic map according to various embodiments; and

FIG. 4 is an exemplary traffic map according to various embodiments.

### DETAILED DESCRIPTION

Systems and methods for generating a traffic map in a mobile device are provided. The mobile device is global positioning system (GPS)-enabled and is able to determine a current location. The mobile device comprises a traffic message receiver configured to receive traffic messages broadcast by a traffic information center. Each of the traffic messages includes an event code and a location code. The traffic message receiver is further configured to decode the event code and the location code to determine an event type and an event location.

The event location, based on the location code, is used to identify a traffic message corresponding to a traffic event within a predetermined distance of the current location. Thus, traffic events that are too far away from the current location to be relevant to the user are not included in the traffic map. The identified traffic message is then used to generate a traffic map covering the current location and the location of the traffic event. For each identified traffic message, the traffic event is indicated by an event graphic corresponding to the event code that is placed on the traffic map according to the event location.

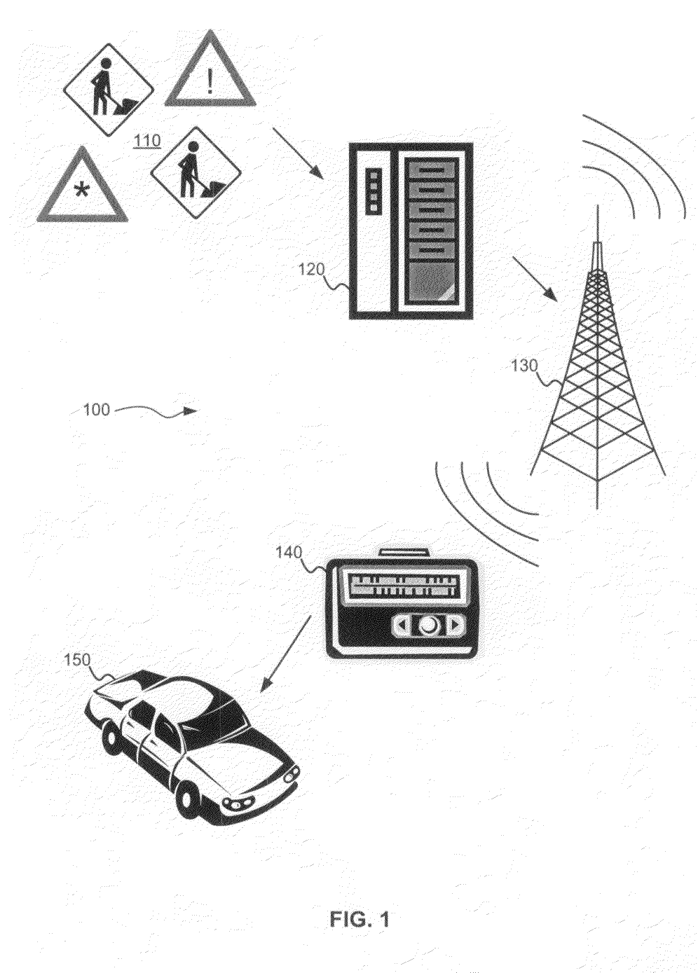

FIG. 1 is an illustration of an exemplary path 100 of a traffic message to the mobile device. The path 100 is used to communicate information about traffic events from the location of the traffic event to a traffic message receiver installed in, for example, an automobile.

At the roadway 110 a traffic event occurs. The traffic event may be construction, an accident, traffic congestion, a weather condition, or the like. Information about the traffic event is communicated by a motorist, emergency services, a traffic monitoring system, or the like from the roadway 110 to a traffic information center 120.

The traffic information center 120 collates the traffic event information and generates a traffic message. The traffic message comprises a series of numerical codes including an event code corresponding to the type of the traffic event and a location code corresponding to the location of the traffic event. The location code may correspond to a point location or a segment of a roadway.

In some embodiments, the traffic message is a Traffic Message Channel (TMC) message according to the ALERT-C coding protocol, as is known in the art. TMC messages include numerical codes to provide information about the traffic event including an event description, location affected, direction and extent of roadway affected, duration of the traffic event, and diversion advice. The numerical codes can be decoded using a publicly available database, as is known in the art. Examples of TMC providers include: TMC Pro, Premium TMC, InfoBlu, Intelematics, TrafficMaster, ClearChannel, Navteq, and TMC. Alternatively or additionally, the traffic message comprises other traffic message data in accordance with one or more other standards such as Traffic Protocol Experts Group (TPEG).

The traffic message is then broadcast by a broadcast station 130. The broadcast station 130 may broadcast the traffic messages via a communications medium such as frequency-modulated (FM) radio, amplitude modulated (AM) radio, cellular communications, satellite radio, Radio Data System-Traffic Message Channel (RDS-TMC), Wireless Fidelity (Wi-Fi), Worldwide Interoperability for Microwave Access (Wi-Max), digital radio, digital audio broadcasting (DAB), digital television (DTV), high definition television (HDTV), or the like. Cellular communications include protocols such as Code Division Multiple Access (CDMA), Universal Mobile Telecommunications System (UMTS), Evolution Data Only (EVDO), and Time Division Multiple Access (TDMA).

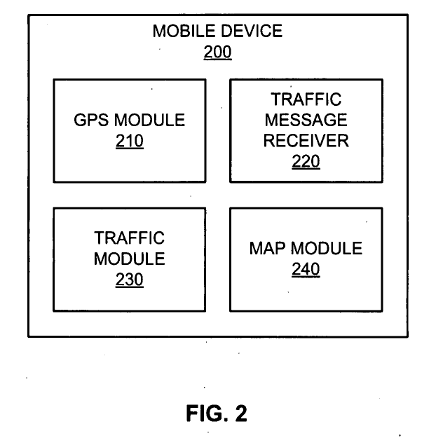

The traffic message is received by the traffic message receiver 140 configured to receive traffic messages from the broadcast station 130. The traffic message receiver 140 is configured to decode the event code in the traffic message using, for example, the publicly available database of event codes. In embodiments using the TMC protocol, the event code may be accompanied by additional information such as a quantifier. In embodiments in which TPEG data is received, a portion of the data is processed by the traffic message receiver 140 to determine an event type. The traffic message receiver 140 additionally determines the location of the traffic event using a separate database that correlates the location codes to a road map. The traffic message receiver 140 may be an embedded component of a mobile device (e.g., a GPS device) discussed herein, at least, in connection with FIG. 2.

The traffic message receiver 140 is typically part of mobile device in an automobile 150. Thus, the driver of the automobile 150 has access to current traffic information. In various embodiments, the mobile device is a handheld device. The mobile device is discussed further herein, at least, in connection with FIG. 2.

FIG. 2 is a block diagram of a mobile device 200 according to various embodiments. The mobile device 200 comprises a GPS module 210, a traffic message receiver 220, a traffic module 230, and a map module 240.

The mobile device 200 comprises one or more computing devices including computer readable media, a processor, and/or logic. For example, the mobile device 200 may comprise a processor (not shown) configured to execute computing instructions stored in the computer readable medium (not shown). These instructions may be embodied in software and divided into the GPS module 210, the traffic message receiver 220, the traffic module 230, and the map module 240. The computer readable medium can be an integrated circuit (IC) memory chip, such as, for example, static random access memory (SRAM), dynamic random access memory (DRAM), synchronous DRAM (SDRAM), non-volatile random access memory (NVRAM), and read only memory (ROM), such as erasable programmable ROM (EPROM), electrically erasable programmable ROM (EEPROM), and flash memory. Alternatively, the mobile device 200 may comprise one or more chips with logic circuitry, such as, for example, an application specific integrated circuit (ASIC), a processor, a microprocessor, a microcontroller, a field programmable gate array (FPGA), a programmable logic device (PLD), a complex programmable logic device (CPLD), or other logic device.

The GPS module 210 is configured to determine a current location of the mobile device 200 as is known in the art. The GPS module 210 additionally correlates the current location to at least one road map.

The traffic message receiver 220, like the traffic message receiver 140, is configured to receive traffic messages from a traffic message center, such as traffic message center 120, via a broadcast station, such as broadcast station 130. The traffic message receiver 210 is configured to receive the traffic messages via at least one of the communications mediums discussed herein, at least, in connection with the broadcast station 130. The traffic message receiver 220 may receive TMC messages, TPEG data, and/or traffic messages in accordance with other standards.

The traffic message receiver 220, upon receiving a traffic message, retrieves information about the type of event and the event location from a copy of the publicly available database of event codes stored in the navigation device 200, as is described herein, at least, in connection with the traffic message receiver 140. In an embodiment of the traffic message receiver 220, the description of the traffic event including the event location is displayed to the user in a “traffic message inbox” interface (not shown).

The traffic module 230 is configured to identify a traffic message having an event location within a predetermined distance of the current location based on the location code. The predetermined distance may be a default value, such as 80 miles. Alternatively, the predetermined distance may be based on an area covered by a traffic map. For example, if the traffic map covers a five mile radius, the predetermined distance is five miles. The predetermined distance may be determined dynamically according to a set of heuristics or based on a user input.

The traffic module 230 is configured to calculate a distance between the current location determined by the GPS module 210 and the event location decoded by the traffic message receiver 220. The calculated distance is then compared to the predetermined distance. If the calculated distance is less than the predetermined distance, the traffic message is identified for inclusion in the traffic map. If, however, the calculated distance is more than the predetermined distance, the traffic message is saved to the “traffic message inbox” that can be accessed by the user or to generate a subsequent traffic map based on a subsequent current location. The traffic message inbox may also include the identified traffic message.

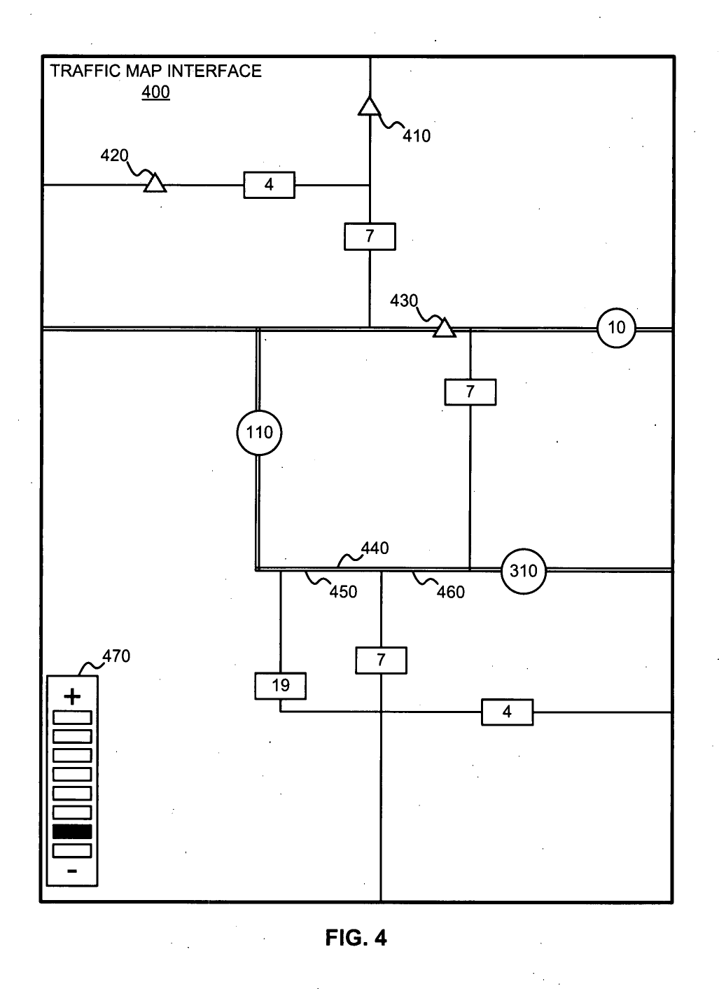

The map module 240 is configured to generate a traffic map of an area comprising the current location and the event location of at least one identified traffic message. The traffic map comprises an event graphic corresponding to the event code of the identified traffic message. The event graphic is placed on the traffic map according to the event location of the identified traffic message. The possible event locations include intersections, city blocks, segments of a freeway between exits, or the like. The possible event locations may be limited to major thoroughfares and bypasses. An exemplary traffic map shown along with a traffic map interface is discussed further herein, at least, in connection with FIG. 4. In some embodiments, the traffic map is generated by adding event graphics to an already existing roadmap based on the location code. In other embodiments, the traffic map is a new map generated from an existing road map and the identified traffic messages.

It will be appreciated that the mobile device 200 illustrated in FIG. 2 is merely an illustrative and non-limiting example of a mobile device according to the present invention. As such, it should be appreciated that the present invention may be embodied in alternate forms.

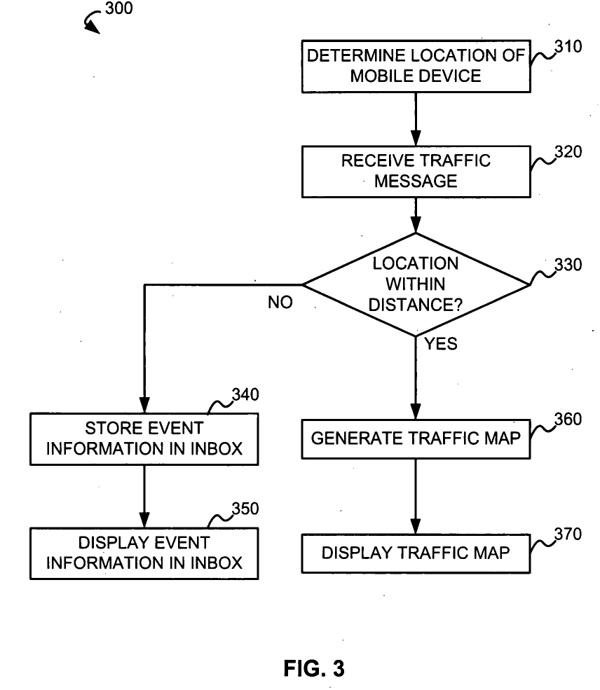

FIG. 3 is a flowchart of an exemplary process 300 for generating a traffic map according to various embodiments. The exemplary process 300 may be performed by a mobile device, such as the mobile device 200.

In a step 310, a current location of the mobile device is determined by a GPS device such as the GPS module 210.

In a step 320, a traffic message about a traffic event is received by a traffic message receiver such as the traffic message receiver 220 (FIG. 2). The traffic message includes a location code and an event code corresponding to an event location and an event type, respectively. It is understood that steps 310 and 320 may be performed in any order.

In a step 330, a determination is made as to whether the event location is within a predetermined distance based on the current location and the event location. In some embodiments, the determination is performed by the traffic module 330.

In a step 340, if the event location is not within the pre-determined distance, information about the traffic event is stored in a traffic message inbox. The traffic message inbox may additionally include information about traffic events within the pre-determined distance.

In a step 350, the event information in the inbox is displayed to the user.

In a step 360, if the event location is within the predetermined distance, a traffic map covering an area comprising the event location is generated. The traffic map may be generated as described herein, at least, in connection with the map module 340.

In a step 370, the traffic map is displayed to the user.

FIG. 4 is an exemplary traffic map interface 400 according to various embodiments. The exemplary traffic map interface 400 is generated by a GPS-enabled mobile device such as mobile device 200 (FIG. 2). The traffic map interface 400 includes a display of a traffic map on the mobile device. Note that this exemplary traffic map includes roadway identifiers (i.e., numbers enclosed in circles or rectangles) as is common with roadway maps.

The traffic map interface 400 includes the traffic map comprising exemplary event graphics 410, 420, 430, 440, 450, and 460. The event graphics 410, 420, 430, 440, 450, and 460 are included on the traffic map based on a location code in identified traffic messages. The event graphics 410, 420, 430, 440, 450, and 460 may each be selectable by a user, in which case, a description of the event depicted by the event graphic is displayed. The description can be retrieved from the traffic message inbox. For example, if event graphic 410 is selected by the user, a description such as “objects on roadway” is displayed to the user. Each event graphic corresponds to a traffic event occurring on a roadway at a single point or to a traffic event occurring over a segment of a roadway. Further, the event graphics may be color-coded according to severity. As events are resolved, change, or occur, it may be desirable to update the traffic map by removing, adding, or changing the event graphics.

For example, the event graphics 410, 420, and 430 correspond to a traffic event occurring on a roadway at a single point. The event graphics 410, 420, and 430 are color-coded according to severity (not shown). For example, the event graphic 410 is gray (not shown) to indicate low severity and corresponds to an event type such as “objects on roadway.” The event graphic 420 is yellow (not shown) to indicate moderate severity and corresponds to an event type such as “turning lane blocked.” The event graphic 430 is red (not shown) to indicate high severity and corresponds to an event type such as “overturned vehicle.”

To update the traffic map, the event graphics 410, 420 and 430 can be removed, changed, or added based on received traffic messages. For example, if the traffic event corresponding to the event graphic 420 ceases to exist, for example, if the turning lane is cleared, the event graphic 420 may be removed. Similarly, if the severity of the event changes, for example, if the overturned vehicle is cleared to one side of the road, the event graphic 430 may be changed to yellow. If another traffic message is received that indicates an accident at another location on the traffic map, an additional event graphic (not shown) may be added to the traffic map.

The event graphics 440, 450 and 460 correspond to speed of traffic on a segment of the roadway. The event graphics 440, 450 and 460 are color-coded (not shown) according to the speed of the traffic. For example, the event graphic is a green segment of the road (not shown) to indicate that traffic is flowing freely. The event graphic 450 is a yellow segment of the road (not shown) to indicate that traffic is moving slower. The event graphic 460 is a red segment of the road (not shown) to indicate that traffic is stopped. The event graphics 440, 450 and 460 may be updated based on received traffic messages. For example, at the end of rush hour, a traffic message may be received indicating that traffic is moving freely at the locations corresponding to the event graphics 450 and 460. In this instance, the event graphics 450 and 460 may be changed to the color green.

In some embodiments, a new traffic map is generated periodically based on an elapsed time or a change in the current location. For example, the traffic map may be replaced by another traffic map based on received traffic messages and/or traffic messages stored in the traffic message inbox. For example, the new traffic map may be generated every two minutes or every ten traveled miles.

The traffic map interface 400 includes a zoom option 470. The zoom option 410 allows a user to adjust the amount of area displayed in the traffic map interface 400. For example, the user may zoom in to view a portion of the map in detail or zoom out to view a larger area to, for example, plan a route.

In some embodiments, the traffic map is regenerated each time a new zoom level is chosen. For example, the predetermined distance used by the traffic module 230 may be based on the zoom level. The traffic messages corresponding to an event location within the predetermined distance based on the zoom level are used to generate a new traffic map.

In other embodiments, a portion of the generated traffic map may be enlarged. In these embodiments, the generated traffic map covers the area being zoomed in. At least because the generated traffic map already includes traffic information about the area being zoomed in, the corresponding portion is enlarged and displayed.

Several embodiments are specifically illustrated and/or described herein. However, it will be appreciated that modification and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a global positioning system module configured to determine a current location;
a traffic message receiver configured to receive traffic messages each comprising an event code and a location code;
a traffic module configured to identify a traffic message of the traffic messages having an event location within a predetermined distance of the current location based on the location code of the traffic message; and
a map module configured to generate a traffic map of an area comprising the current location and the event location of the identified traffic message, the traffic map comprising an event graphic corresponding to the event code of the identified traffic message, the event graphic placed on the traffic map according to the event location of the identified traffic message.

2. The system of claim 1, wherein the traffic module is configured to store the traffic messages in a traffic message inbox.

3. The system of claim 1, wherein the traffic messages are in accordance with a standard.

4. The system of claim 1, wherein the predetermined distance is based on a zoom level of the traffic map.

5. The system of claim 1, wherein the predetermined distance is received from a user.

6. The system of claim 1, wherein the event graphic is color-coded based on a severity of the event code of the identified traffic message.

7. The system of claim 1, wherein the event location is a point location on a road.

8. The system of claim 1, wherein the event location is a segment of a road.

9. The system of claim 1, wherein the map module is configured to generate the traffic map on a periodic basis.

10. The system of claim 1, wherein the map module is configured to update the traffic map.

11. The system of claim 1, wherein the map module is configured to generate the traffic map by adding the event graphic to a road map.

12. The system of claim 1, wherein the map module is configured to generate the traffic map based on a road map and the identified traffic message.

13. The system of claim 1, wherein the map module is configured to generate the traffic map based on a zoom level received from a user.

14. A method comprising:
determining a current location of a mobile device;
receiving, at the mobile device, traffic messages each comprising an event code and a location code;
identifying a traffic message of the traffic messages having an event location within a predetermined distance of the current location based on the location code of the traffic message; and
generating a traffic map of an area comprising the current location and the event location of the identified traffic message, the traffic map comprising an event graphic corresponding to the event code of the identified traffic message, the event graphic placed on the traffic map according to the event location of the identified traffic message.

15. The method of claim 14, further comprising storing the received traffic message in a traffic message inbox.

16. The method of claim 14, wherein the traffic messages are in accordance with a standard.

17. The method of claim 14, further comprising:
identifying an other traffic message having an other event location within the predetermined distance of the current location based on an other location code of the traffic message; and
generating an other traffic map of the area comprising the current location and the event location of the other identified traffic message, the other traffic map comprising an other event graphic corresponding to an other event code of the other identified traffic message, the other event graphic placed on the other traffic map according to the other event location of the other identified traffic message.

18. The method of claim 14, further comprising,
identifying an other traffic message having an other event location within the predetermined distance of the current location based on the other location code of the other traffic message; and
updating the traffic map of the area comprising the current location and the event location of the identified traffic message, the updated traffic map comprising an other event graphic corresponding to the other event code of the other identified traffic message, the other event graphic placed on the traffic map according to the other event location of the other identified traffic message.

19. The method of claim 14, wherein the pre-determined distance is based on a zoom-level of the traffic map.

20. A computer readable medium having embodied thereon instructions executable by a
processor for performing a method for generating a traffic map, the method comprising:
determining a current location of a mobile device;
receiving, at the mobile device, traffic messages each comprising an event code and a location code;
identifying a traffic message of the traffic messages having an event location within a predetermined distance of the current location based on the location code of the traffic message; and
generating a traffic map of an area comprising the current location and the event location of the identified traffic message, the traffic map comprising an event graphic corresponding to the event code of the identified traffic message, the event graphic placed on the traffic map according to the event location of the identified traffic message.
